(19) United States
(12) Patent Application Publication
(10) Pub. No.: US 2013/0316042 A1
(43) Pub. Date: Nov. 28, 2013

(54) ENHANCED RELEASE OF LIPOPHILIC INGREDIENTS FROM CHEWING GUM WITH HYDROCOLLOIDS

(71) Applicants: Junjie Guan, Tenafly, NJ (US); Tasoula A. Michaelidou, Cresskill, NJ (US); Juan Pablo Campomanes Marin, Puebla (MX); Aditi Shetty, Morris Plains, NJ (US); Tinyee Hoang, Parsippany, NJ (US)

(72) Inventors: Junjie Guan, Tenafly, NJ (US); Tasoula A. Michaelidou, Cresskill, NJ (US); Juan Pablo Campomanes Marin, Puebla (MX); Aditi Shetty, Morris Plains, NJ (US); Tinyee Hoang, Parsippany, NJ (US)

(73) Assignees: CADBURY ADAMS MEXICO, S. DE R.L. DE C.V., Delegacion Cuajimalpa (MX); KRAFT FOODS GLOBAL BRANDS LLC, Deerfield, IL (US)

(21) Appl. No.: 13/806,294

(22) PCT Filed: Jun. 21, 2011
(86) PCT No.: PCT/US11/41135

§ 371 Date: Aug. 5, 2013

Related U.S. Application Data
(60) Provisional application No. 61/358,445, filed on Jun. 25, 2010.

(51) Int. Cl. A23G 4/10

(52) U.S. Cl. CPC A23G 4/10
USPC 426/3

(57) ABSTRACT

Disclosed herein are chewing gum compositions comprising a pectin and a lipophilic ingredient. It has been found that the use of the pectin in a chewing gum composition provides for an enhanced release of the lipophilic ingredient, such as lipophilic flavor and lipophilic sensate compounds.

### FIELD

This disclosure generally relates to incorporation of a hydrocolloid, such as pectin, to enhance the release of lipophilic ingredients, such as lipophilic flavorant and lipophilic sensate compounds, from chewing gum.

### BACKGROUND

Chewing gums available today generally contain a water-insoluble gum base, sweeteners, natural or artificial flavors, and a variety of additional components tailored to provide specific flavor characteristics and mouthfeel. Oral delivery of actives, such as flavors, sweeteners, sensates and therapeutic agents, for their intended purpose, is one of the main objectives of chewing gum compositions. For example, some chewing gums can include sensates which provide the consumer with a cooling, warming, or tingling sensation. A variety of physiological cooling agents have been used in chewing gum formulations to provide a cooling sensation upon consumption by the user.

A significant effort in the chewing gum industry has been directed to improving the release and stabilization of lipophilic ingredients, which include flavors and certain sensate compounds such as cooling agents. Many such sensates are hydrophobic or lipophilic. As these ingredients are lipophilic, they are often retained in the lipophilic portion of a chewing gum composition such as the rubber/elastomeric polymer portion. The result is the loss of the effectiveness of the lipophilic ingredients, such as for example, the cooling effect of a cooling sensate.

Lipophilic, low water soluble ingredients are very difficult to release from chewing gum without modification of their physical form, such as encapsulation by using spray drying, spray coating, and other matrix encapsulation techniques.

There is therefore a need for chewing gum compositions that can enhance the release of lipophilic ingredients. Furthermore, there is a need for chewing gum compositions to provide enhanced sensate effect while at the same time maintaining the consumer acceptance of the chewing gum texture.

### SUMMARY

In one embodiment, a chewing gum composition comprises about 5% to about 90% by weight gum base; about 5% to about 95% by weight bulking and sweetening agents; about 0.001% to about 5.0% by weight of a lipophilic flavorant or lipophilic sensate; and about 0.01% to about 10% by weight of pectin, wherein the pectin is unswollen and unhydrated, and wherein the pectin is incorporated directly into the chewing gum composition in a powder form and not as an encapsulant or an agglomerating agent.

In another embodiment, a method of making a chewing gum composition comprises melting a gum base to form a molten gum base; mixing a bulking and sweetening agent with the molten gum base to form first mixture; mixing a lipophilic sensate, a lipophilic flavorant, or a combination thereof into the first mixture to form a second mixture; and mixing about 0.01% to about 10% by weight of powdered pectin into the molten gum base, the first mixture, or the second mixture, wherein the pectin is unswollen and unhydrated, and wherein the pectin is not as an encapsulant or an agglomerating agent.

The above described and other features are exemplified by the following detailed description.

### DETAILED DESCRIPTION

The present inventors have observed that adding a pectin in an unswollen, unhydrated and powder form, directly into a chewing gum composition, significantly enhances the release of the lipophilic ingredients from chewing gum during mastication. Without being bound by theory, it is believed the pectin increases saliva penetration into the chewing gum bolus during mastication, resulting in a higher percent extraction of the lipophilic ingredients from the chewing gum.

Moreover, the present inventors have observed that a specific combination of an unswollen, unhydrated and powdered pectin, and a lipophilic flavorant or lipophilic sensate exhibits a significantly enhanced flavoring release. This enhanced flavoring release is particularly surprising given that the unswollen, unhydrated and powdered pectin is not complexed with the lipophilic flavorant or sensate as it would be if the pectin were used as an encapsulant or agglomerating agent.

Pectin is known for its use as a demulcent in throat drops to provide throat soothing. However, the present inventors have observed that a chewing gum containing the combination of a low amount of unswollen, unhydrated, powder pectin with N-ethyl-2,2 diisopropylbutanamide showed significant enhancement of cooling in the back of the throat as compared to chewing gum containing N-ethyl-2,2 diisopropylbutanamide in the absence of pectin. This is surprising since pectin, which is used in throat drops for throat soothing, would be expected to decrease throat sensations rather than providing a sensation enhancement in the throat.

Further, the present inventors have observed that the addition of an unswollen, unhydrated, powder pectin further allows for a reduction in the amount of rubber needed in a chewing gum composition, while maintaining consumer acceptance of an acceptable chew texture characteristic. The low amount of rubber in turn reduces the amount of interactions between the rubber and lipophilic ingredients in the chewing gum, and improves the release of the lipophilic ingredients from the gum matrix during chewing.

Embodiments described herein pertain to unswollen, unhydrated and powder forms of pectin, wherein the pectin is incorporated directly into the chewing gum composition in a dry powder form and not as an encapsulant or an agglomerating agent.

### Pectin

Pectins are polysaccharides that are derived from structural components in fruits and vegetables. Commercial raw material sources include citrus peels, apple peels and sugar beets. Pectin provides multiple functions such as viscosity, texture, gelation (thickener, stabilizer) and protein stability for a numerous food applications.

Pectins are a family of complex polysaccharides that contain 1,4-linked α-D-galactosyluronic acid residues. Three pectic polysaccharides have been isolated from plant primary cell walls and structurally characterized. These are: homogalacturonans, substituted galacturonans, and rhamnogalacturonans. Homogalacturonans are linear chains of α-(1-4)-linked D-galacturonic acid, such as shown in the example below:

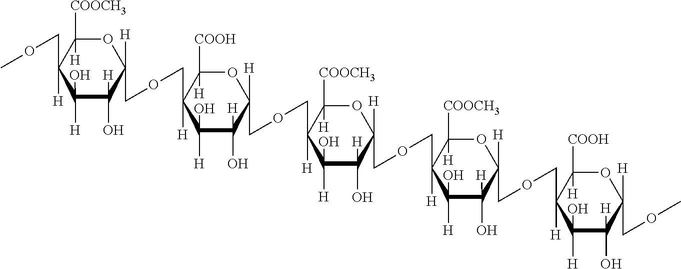

There are two basic types of pectin, differing in Degree of methyl Esterification (DE). High methylester (HM) pectin has a DE higher than 50 and forms gels at low pH (below 3.5) and high solids (55% or higher). Calcium ions are not required for gelation. Low methylester (LM) pectin has a DE lower than 50. Gelation occurs within the pH range of 1-7 and soluble solids (0-85%) and requires divalent cations such as calcium. There is also a third type of pectin called low methylester amidated (LMA) pectin obtained by treating a liquid extract of the relevant plant material (e.g. citrus peel) with ammonia that is used to de-esterify the pectin. The resulting pectin molecule contains amide groups.

In general, the maximum stability of pectin is at pH 4. At low pH and elevated temperatures, de-esterification and degradation via hydrolysis of glycosidic linkages occurs. HM pectin loses viscosity and gelation properties at near-neutral pH when at elevated temperatures. LM pectin is more stable than HM pectin at near-neutral pH and elevated temperatures. However, both types of pectin degrade at alkaline pH values (even at room temperature).

Pectin gelation is affected by temperature, pectin type, pH, sugar and other solutes, and calcium ions.

Molecular weight of pectin affects its gelling strength. High molecular weight pectin provides high breaking strength to gels. Isolated pectin has a molecular weight of typically 60-130,000 g/mol, varying with origin and extraction conditions.

In several embodiments, the pectin used in the chewing gum herein is not gelled, hydrated or swollen with a solvent (e.g., water). Rather, it is used in a dry powder form, specifically a free-flowing dry powder form. Furthermore, the powdered pectin is not used as an agglomerating agent or as an encapsulant or coating ingredient. In specific embodiments, the pectin is in a dry, powder form, which exhibits a loss on drying of less than or equal to 10.0%. Dry, powder form is intended to mean that the product be pourable without substantial caking, is unswollen and unhydrated.

Suitable powdered pectins are commercially available and include, for example, Genu® Pectin available from CP Kelco, such as Genu® Pectin type USP-L/200 (a high methoxyl pectin; galacturonic acid ≧74.0%; methoxy groups ≧6.7%; free of standardizing agents such as sucrose, dextrose, or buffer salts; particle size, 0.075 mm≦1.0%; loss on drying, ≦10.0%); the pectins available from Pacific Pectin, Inc.; and Grindsted® pectins available from Danisco, including Grindsted® SF, SF Extra, CF, Prime, and USP.

In several embodiments, the unswollen, unhydrated and powder pectin meets the requirements of the United States Pharmacopoeia (USP) monograph for pectin (United States Pharmacopoeia and National Formulary: USP 31).

In another embodiment, the particle size of the powdered pectin is greater than or equal to about 50 micrometers, specifically greater than or equal to about 65 micrometers, more specifically greater than or equal to about 70 micrometers, and still yet more specifically greater than or equal to about 75 micrometers, as determined by sieve analysis. The upper limit of particle size can be less than or equal to about 2000 micrometers, specifically less than or equal to about 1000 micrometers, more specifically less than or equal to about 500 micrometers, and yet more specifically less than or equal to about 250 micrometers, as determined by sieve analysis.

The amount of unswollen and unhydrated pectin added in the form of a powder to a chewing gum composition can be about 0.01 to about 10 weight percent of the chewing gum composition based on the weight of the chewing gum composition, specifically about 0.1 to about 7 weight percent, more specifically about 0.15 to about 4 weight percent, yet more specifically about 0.3 to about 1 weight percent, and still yet more specifically about 0.4 to about 0.5 weight percent. In additional embodiments, the amount of unswollen and unhydrated pectin added in the form of a powder to a chewing gum composition can be about 0.01 to about 1.0 weight percent of the chewing gum composition based on the weight of the chewing gum composition, specifically about 0.05 to about 0.7 weight percent, more specifically about 0.15 to about 0.6 weight percent, yet more specifically about 0.25 to about 0.5 weight percent, and still yet more specifically about 0.3 to about 0.4 weight percent.

In one embodiment, the pectin is in the form of particles consisting of pectin. In one embodiment, the pectin is in the form of particles consisting of pectin and optionally a bulk sweetener (e.g. sucrose or dextrose) and an optional buffer salt. In another embodiment, the pectin is in the form of particles consisting of pectin and optionally a bulk sweetener (e.g. sucrose or dextrose) and an optional buffer salt, where the pectin is coated with a polymer. Within this embodiment the polymer can include polyvinyl alcohol or polyvinyl acetate. In yet another embodiment, the pectin is in the form of particles consisting of pectin and optionally a bulk sweetener (e.g. sucrose or dextrose) and an optional buffer salt, where the pectin is dispersed in a polymer matrix. Within this embodiment the polymer can include polyvinyl alcohol or polyvinyl acetate.

In other embodiments, the pectin is not in a powdered form, but is in the form of an edible film including edible film particles comprising pectin. In another embodiment, the pectin is in the form of a coating on a chewing gum ingredient, excluding a coating on a lipophilic ingredient such as a lipophilic flavorant or a lipophilic sensate.

### Lipophilic Ingredients

The chewing gum composition further comprises a lipophilic ingredient. A “lipophilic ingredient” refers to an ingredient that is not readily solubilized in water. Exemplary lipophilic ingredients include lipophilic sensates, which include lipophilic cooling agents, lipophilic warming agents, lipophilic tingling agents, and combinations thereof; and lipophilic flavorants such as oil based flavorants; and combinations thereof.

In one aspect, the lipophilic ingredient is one having a partition coefficient between octanol and water (log P (octanol/water) at 25° C.) of greater than or equal to 1.5, specifically greater than or equal to 2.0, more specifically greater than or equal to 2.5, yet more specifically greater than or equal to 3.0, still yet more specifically greater than or equal to 3.5, and more specifically greater than or equal to 4.0. The partition coefficient of material can be determined experimentally or calculated using commercially available software. The log P values for exemplary lipophilic flavorants and lipophilic sensates are provided in the table below.

| | logP (octanol/water) |
|---|---|
| | at 25° C. or |
| Flavorant/Sensate | calculated (XlogP) |
| N,2,3-trimethyl-2-propan-2-ylbutanamide | 2.48 |
| (WS-23) | |
| ethyl 2-[(5-methyl-2-propan-2- | 3.38 |
| ylcyclohexanecarbonyl)amino]acetate (WS-5) | |
| menthol | 3.40 |
| spilanthol | 3.4 |
| N-ethyl-2,2-diisopropylbutanamide | 3.60 |
| N-ethyl-p-menthane-3-carboxamide (WS-3) | 3.81 |
| monomenthyl glutarate | 4.12 |
| vanillyl alcohol ethylether | XlogP: 1.70 |
| vanillyl alcohol n-butylether | XlogP: 2.60 |
| menthone | XlogP: 2.80 |
| menthyl lactate | XlogP: 3.40 |
| trans-pellitorin | XlogP: 4.50 |
| capsaicin | XlogP: 4.60 |

When used in a chewing gum containing unswollen and unhydrated pectin in powdered form, the amount of lipophilic sensate can be about 0.001 to about 5.0 weight percent based on the weight of the chewing gum, specifically about 0.01 to about 4.0 weight percent, more specifically about 0.10 to about 3.0 weight percent, yet more specifically about 0.20 to about 2.0 weight percent, and still yet more specifically about 0.50 to about 1.0 weight percent.

When used in a chewing gum containing unswollen and unhydrated pectin in powdered form, the amount of lipophilic flavorant can be about 0.001 to about 5.0 weight percent based on the weight of the chewing gum, specifically about 0.01 to about 4.0 weight percent, more specifically about 0.10 to about 3.0 weight percent, yet more specifically about 0.20 to about 2.0 weight percent, and still yet more specifically about 0.50 to about 1.0 weight percent.

Exemplary cooling agents include menthane; menthone; ketals; menthone ketals; menthone glycerol ketals; substituted p-menthanes; acyclic carboxamides; monomenthyl glutarate; substituted cyclohexanamides; substituted cyclohexane carboxamides; substituted ureas and sulfonamides; substituted menthanols; hydroxymethyl and hydroxymethyl derivatives of p-menthane; 2-mercapto-cyclo-decanone; hydroxycarboxylic acids with 2-6 carbon atoms; cyclohexanamides; menthyl acetate; menthyl salicylate; N,2,3-trimethyl-2-propan-2-ylbutanamide (WS-23); N-ethyl-p-menthane-3-carboxamide (WS-3); ethyl ester of N-[[5-methyl-2-(1-methylethyl)cyclohexyl]carbonyl]glycine (WS-5, ethyl 3-(p-menthane-3-carboxamido)acetate, ethyl 2-[(5-methyl-2-propan-2-ylcyclohexanecarbonyl)amino]acetate); as well as the substantially pure ethyl ester of N-[[5-methyl-2-(1-methylethyl)cyclohexyl]carbonyl]glycine as disclosed in U.S. Pat. No. 7,189,760 to Erman, et al which is incorporated in its entirety herein by reference; isopulegol; menthyloxy propane diol; 3-(1-menthoxy)propane-1,2-diol; 3-(1-menthoxy)-2-methylpropane-1,2-diol; p-menthane-2,3-diol; p-menthane-3,8-diol; 6-isopropyl-9-methyl-1,4-dioxaspiro[4,5]decane-2-methanol; menthyl succinate and its alkaline earth metal salts; N-(4-(cyanomethyl)phenyl)-2-isopropyl-5-methylcyclohexane-carboxamide (Evercool™ 180); trimethylcyclohexanol; N-ethyl-2-isopropyl-5-methylcyclohexanecarboxamide; Japanese mint oil; peppermint oil; 3-(1-menthoxy)ethan-1-ol; 3-(1-menthoxy)propan-1-ol, 3-(1-menthoxy)butan-1-ol; 1-menthylacetic acid N-ethylamide; 1-menthyl-4-hydroxypentanoate; 1-menthyl-3-hydroxybutyrate; N-2,3-trimethyl-2-(1-methylethyl)-butanamide; N,N-dimethyl menthyl succinamide; substituted p-menthanes; substituted p-menthane-carboxamides; menthyl esters; 2-isopropanyl-5-methylcyclohexanol (from Hisamitsu Pharmaceuticals, hereinafter “isopregol”); menthone glycerol ketals (FEMA 3807, tradename FRESCOLAT® type MGA); 3-1-menthoxypropane-1,2-diol (from Takasago, FEMA 3784); menthyl lactate (from Haarman & Reimer, FEMA 3748, tradename FRESCOLAT® type ML); WS-30; WS-14; Eucalyptus extract (p-menthane-3,8-Diol); Menthol (its natural or synthetic derivatives); Menthol PG carbonate; Menthol EG carbonate; Menthol glyceryl ether; N-tertbutyl-p-menthane-3-carboxamide; P-menthane-3-carboxylic acid glycerol ester; Methyl-2-isopryl-bicyclo (2.2.1), Heptane-2-carboxamide; Menthol methyl ether; menthyl pyrrolidone carboxylate; 2,5-dimethyl-4-(1-pyrrolidinyl)-3(2H)-furanone; cyclic α-keto enamines; cyclotene derivatives such as cyclopentenes including 3-methyl-2-(1-pyrrolidinyl)-2-cyclopenten-1-one and 5-methyl-2-(1-pyrrolidinyl)-2-cyclopenten-1-one; compounds of the formula:

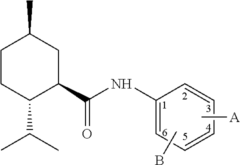

wherein B is selected from H, CH₃, C₂H₅, OCH₃, OC₂H₅; and OH; and wherein A is a moiety of the formula-CO-D, wherein D is selected from the following moieties: (i)-NR¹R², wherein R¹ and R² are independently selected from H and C₁-C₈ straight or branched-chain aliphatic, alkoxyalkyl, hydroxyalkyl, araliphatic and cycloalkyl groups, or R¹ and R² together with the nitrogen atom to which they are attached form part of an optionally-substituted, five- or six-membered heterocyclic ring; (ii)-NHCH₂COOCH₂CH₃, —NHCH₂CONH₂, —NHCH₂CH₂OCH₃, —NHCH₂CH₂OH, —NHCH₂CH(OH)CH₂OH and (iii) a moiety selected from the group consisting of:

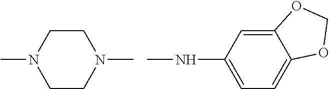

as disclosed in PCT Patent Application WO2006/125334 to Bell et al which is incorporated in its entirety herein by reference, among others. Other compounds include the alpha-keto enamines disclosed in U.S. Pat. No. 6,592,884 to Hofmann et al which is incorporated in its entirety herein by reference. These and other suitable cooling agents are further described in the following U.S. patents, all of which are incorporated in their entirety by reference hereto: U.S. Pat. Nos. 4,230,688; 4,032,661; 4,459,425; 4,178,459; 4,296,255; 4,136,163; 5,009,893; 5,266,592; 5,698,181; 6,277,385; 6,627,233; 7,030,273. Still other suitable cooling agents are further described in the following U.S. Patent Applications, all of which are incorporated in their entirety by reference hereto: U.S. 2005/0222256; 2005/0265930.

Exemplary lipophilic cooling agents having a log P of greater than or equal to 1.5 include N-(4-(cyanomethyl)phenyl)-2-isopropyl-5-methylcyclohexane-carboxamide, N-ethyl-2,2-diisopropylbutanamide, N-ethyl-p-menthane-3-carboxamide, ethyl 2-[(5-methyl-2-propan-2-ylcyclohexanecarbonyl)amino]acetate, menthol (its natural or synthetic derivatives), menthone, monomenthyl glutarate, menthyl lactate, N,2,3-trimethyl-2-propan-2-ylbutanamide, and combinations thereof.

In a specific embodiment of the chewing gum composition, the lipophilic ingredient comprises N-ethyl-2,2-diisopropylbutanamide, which can provide the sensation of throat cooling when consumed in a confectionary composition. The structure of N-ethyl-2,2-diisopropylbutanamide is shown below.

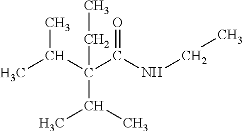

N-Ethyl-2,2-diisopropylbutanamide is a known compound, having been described in Great Britain U.S. Pat. No. 1,421,744 to Rowsell et al. In that reference, it is one of a family of acyclic carboxamides that is characterized as exhibiting physiological cooling activity. In particular, the family of compounds is characterized as “having a physiological cooling effect on the skin and on the mucous membranes of the body, particularly the mucous membranes of the nose and bronchial tract.” GB 1,421,744 to Rowsell et al., page 1, lines 12-15. The Rowsell patent includes a Table in which each compound's “cooling activity” is indicated by a scale of one to five asterisks, but the procedure by which cooling activity was evaluated is not provided, and there is no specific indication of throat-cooling activity.

When used in a chewing gum containing unswollen and unhydrated pectin in powdered form, the amount of N-ethyl-2,2-diisopropylbutanamide can be about 0.01 to about 1 weight percent based on the weight of the chewing gum, specifically about 0.1 to about 0.9 weight percent, more specifically about 0.15 to about 0.8 weight percent, yet more specifically about 0.2 to about 0.6 weight percent, and still yet more specifically about 0.25 to about 0.3 weight percent.

In order to emphasize throat cooling over mouth cooling, N-ethyl-2,2-diisopropylbutanamide can be used as the sole or primary physiological cooling agent in the chewing gum composition. Alternatively, e.g., when a combination of mouth cooling and throat cooling is desired, N-ethyl-2,2-diisopropylbutanamide can be used in combination with other physiological cooling agents. In general, it should be noted that that the use of cooling agents in gum and confections pose different formulation challenges. In chewing gum, release of the cooling agents is influenced by partitioning of the cooling agents between the gum base and the essentially aqueous environment of the mouth. In contrast, release of cooling agents from confections, such as hard candy, is controlled largely by the surface area and dissolution rate of the hard candy.

Combinations of N-ethyl-2,2-diisopropylbutanamide with other physiological cooling agents are possible. Other physiological cooling agents that can be used in the chewing gum along with N-ethyl-2,2-diisopropylbutanamide include those previously discussed above.

Exemplary warming agents can be selected from a wide variety of compounds known to provide the sensory signal of warming to the user. These compounds offer the perceived sensation of warmth, particularly in the oral cavity, and often enhance the perception of flavors, sweeteners and other organoleptic components. Among the useful warming compounds include vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamylether, vanillyl alcohol n-hexylether, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, and a combination thereof.

In some embodiments, a tingling agent may be employed to provide a tingling, stinging, or numbing sensation to the user. Exemplary tingling agents include Jambu Oleoresin or para cress (Spilanthes sp.), in which the active ingredient is Spilanthol; Japanese pepper extract (Zanthoxylum peperitum), including the ingredients known as Saanshool-I, Saanshool-II and Sanshoamide; perillartine; 4-(1-menthoxymethyl)-2-phenyl-1,3-dioxolane; black pepper extract (piper nigrum), including the active ingredients chavicine and piperine; Echinacea extract; Northern Prickly Ash extract; trans-pellitorin, and red pepper oleoresin. In some embodiments, alkylamides extracted from materials such as jambu or sanshool may be included.

In several embodiments, the tingling agent is spilanthol. The compound spilanthol is an unsaturated alkylamide, specifically an isobutylamide, having the chemical name N-isobutyl-2E,6Z,8E-decatrienamide or (2E,6Z,8E)-deca-2,6,8-trienoic acid N-isobutyl amide. Spilanthol can be provided by adding a jambu extract, for example, jambu oleoresin, which contains spilanthol. Other alkylamides extracted from jambu can be included, but spilanthol is the primary one and is typically present in the oleoresin in an amount of 20 to 50 weight percent, specifically 25 to 40 weight percent. Other details of the source and preparation of jambu extracts can be found in U.S. Pat. No. 6,780,443, the entire contents of which are incorporated herein by reference for all purposes. Spilanthol can be obtained from plants, including the leaves and flower heads, of the genera genera Achilla (yarrow), Acmella (spotflower), Echinacea (purple cornflower), and Spilanthes (spilanthes) of the family Asteraceae. The compound spilanthol can also be extracted from grass root (in which spilanthol is referred to as “affinin”). For example, spilanthol is present in Heliopisis longipes roots in concentrations as high as 1 weight percent.

In addition to botanical sources, spilanthol can be prepared synthetically, i.e. not obtained as a natural product. Spilanthol can also be prepared synthetically, as disclosed in WO 2009/091040. Jambu oleoresin (Spilanthes Acmella) or other spilanthol-containing extracts are commercially available from various vendors, including Robertet, Inc. (Grasse, France.)

Synthetic spilanthol, being more pure than botanical sources, can be distinguished to some extent based on taste sensations. Synthetic spilanthol can have a purity of at least about 90 percent. In some embodiments, synthetic spilanthol can provide relatively higher mouth-moistening relative to tingling or heating sensations, compared to, for example, equivalent amounts of spilanthol in jambu. Synthetic spilanthol can provide a cleaner profile and/or less tingling, based on taste testing, than some comparable plant extracts. In one embodiment a combination of synthetic spilanthol and a spilanthol-containing plant extract is used. For example, within the given range of 20 to 60 ppm spilanthol, the amount of spilanthol provided by synthetic spilanthol can vary from 20 to 80 weight percent and the amount of spilanthol provided by plant extract such as jambu can vary from 80 to 20 weight percent.

The lipophilic flavorants, which may be used include those flavors known to the skilled artisan, such as natural and artificial flavors. The flavorants may provide a fruit, herb, spice, or savory flavor. These flavorants may be chosen from synthetic flavor oils and flavoring aromatics and/or oils, oleoresins and extracts derived from plants, leaves, flowers, fruits, and so forth, and combinations thereof. Non-limiting representative flavor oils include spearmint oil, cinnamon oil, oil of wintergreen (methyl salicylate), peppermint oil, clove oil, bay oil, anise oil, eucalyptus oil, thyme oil, cedar leaf oil, oil of nutmeg, allspice, oil of sage, mace, oil of bitter almonds, and cassia oil. Also, useful flavorants are artificial, natural and synthetic fruit flavors such as vanilla, and citrus oils including lemon, orange, lime, grapefruit, and fruit essences including apple, pear, peach, grape, strawberry, raspberry, cherry, plum, pineapple, apricot and so forth. These flavorants may be used in liquid or solid form and may be used individually or in admixture. Commonly used flavorants include mints such as peppermint, artificial vanilla, cinnamon derivatives, and various fruit flavors, whether employed individually or in admixture.

Other useful flavorants include aldehydes and esters such as cinnamyl acetate, cinnamaldehyde, citral diethylacetal, dihydrocarvyl acetate, eugenyl formate, p-methylamisol, and so forth may be used. Generally any lipophilic flavoring or food additive such as those described in Chemicals Used in Food Processing, publication 1274, pages 63-258, by the National Academy of Sciences, may be used.

### Chewing Gum Compositions

The chewing gum compositions disclosed herein may be varied to suit the type of gum produced i.e. chewing or bubble gum. As used herein, the terms “bubble gum” and “chewing gum” are used interchangeably and are both meant to include any gum composition.

The chewing gum compositions may be coated or uncoated, and be in the form of slabs, sticks, pellets, balls, and the like. The composition of the different forms of the chewing gum compositions will be similar but may vary with regard to the ratio of the ingredients. For example, coated chewing gum compositions may contain a lower percentage of softeners. Pellets and balls may have a chewing gum core, which has been coated with either a sugar solution or a sugarless solution to create the hard shell. Slabs and sticks are usually formulated to be softer in texture than the chewing gum core. In some cases, an hydroxy fatty acid salt or other surfactant actives may have a softening effect on the gum base.

The chewing gum composition generally comprises a gum base, a bulk sweetener, a lipophilic ingredient such as a lipophilic sensate (e.g., N-ethyl-2,2-diisopropylbutanamide), and unswollen and unhydrated pectin that is incorporated directly into the chewing gum composition in a dry powder form and not as an encapsulant or an agglomerating agent. Additional ingredients may include an artificial or high intensity sweetener, an additional flavorant, a coloring agent, an emulsifier, an additional sensate, a softener, or a combination thereof. Still further optional additives, including throat-soothing agents, tooth-whitening agents, breath-freshening agents, vitamins, minerals, caffeine, drugs (e.g., medications, herbs, and nutritional supplements), oral care products, and combinations thereof.

The gum base employed in the chewing gum compositions may vary depending upon factors such as the type of base desired, the consistency of gum desired and the other components used in the composition to make the final chewing gum product. The gum base may be any water-insoluble gum base known in the art, and includes those gum bases utilized for chewing gums and bubble gums. Illustrative examples of suitable polymers in gum bases include both natural and synthetic elastomers and rubbers. In this regard, polymers which are suitable as gum bases include, without limitation, elastomers of vegetable origin such as chicle, natural rubber, crown gum, nispero, rosidinha, jelutong, perillo, niger gutta, tunu, balata, guttapercha, lechi capsi, sorva, gutta kay, combinations thereof, and the like. Synthetic elastomers such as butadiene-styrene copolymers, polyisobutylene, isobutylene-isoprene copolymers, polyethylene, combinations thereof, and the like, are also useful. Suitable gum bases may also include a non-toxic vinyl polymer, such as polyvinyl acetate and its partial hydrolysate, polyvinyl alcohol, and combinations thereof. When utilized, the molecular weight of the vinyl polymer may range from about 2,000 to about 94,000 Daltons (Da).

In several embodiments, when the powdered pectin is used in the chewing gum composition, the amount of rubber in the gum base can be reduced to 0 to about 3 weight percent based on the weight of the gum base, specifically about 1 to about 2 weight percent. Such chewing gum compositions provide enhanced release of lipophilic ingredients as there is less amount of rubber available to inhibit the release of the ingredients. Furthermore, it has been unexpectedly found that even with the reduced amount of rubber, the presence of the pectin provides a good chew texture to the chewing gum, giving the texture during chew sufficient bounciness.

The amount of gum base employed will vary greatly depending upon various factors such as the type of base used, the consistency of the gum desired, and the other components used in the composition to make the final chewing gum product. In general, the gum base will be present in amounts of about 5 to about 90 weight percent of the final chewing gum composition, specifically about 10 to about 70 weight percent, more specifically about 20 to about 50 weight percent, and yet more specifically about 25 to about 30 weight percent of the final chewing gum product.

The gum base may also include plasticizers or softeners such as lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, combinations thereof, and the like. Waxes, for example, natural and synthetic waxes, hydrogenated vegetable oils, organic waxes such as polyurethane waxes, polyethylene waxes, paraffin waxes, microcrystalline waxes, fatty waxes, sorbitan monostearate, tallow, polypropylene glycol, combinations thereof, and the like, may also be incorporated into the gum base. Such materials are incorporated into the gum base to provide a variety of desirable textures and consistency properties. Because of the low molecular weight of these ingredients, they are able to penetrate the fundamental structure of the gum base making it plastic and less viscous. These additional materials are generally employed in amounts up to about 18 weight percent, specifically in amounts from about 5 to about 18 weight percent, and more specifically in amounts from about 10 to about 14 weight percent of the gum base.

In one embodiment, the softening agent is glycerin, such as the commercially available United States Pharmacopeia (USP) grade. Glycerin is a syrupy liquid with a sweet warm taste and has a sweetness of about 60% of cane sugar. Glycerin can be used in the gum base in various amounts. Specifically the amount of glycerine, when used, may be present in an amount of about 0 to about 15 weight percent of the chewing gum composition, more specifically about 1 to about 10 weight percent, and even more specifically about 4.5 to about 6.0 weight percent of the chewing gum composition.

The gum base may include effective amounts of bulking agents such as mineral adjuvants, which can serve as fillers and textural agents. Examples of such mineral adjuvants include calcium carbonate, magnesium carbonate, alumina, aluminum hydroxide, aluminum silicate, talc, titanium dioxide, tricalcium phosphate, dicalcium phosphate and the like, as well as combinations thereof. These fillers or adjuvants may be used in the gum base in various amounts. Specifically the amount of filler, when used, may be present in an amount of about 0 to about 60 weight percent of the gum base, and more specifically from about 20 to about 30 weight percent of the gum base.

The combination of pectin with a high filler content in the gum base enhances the release of lipophilic ingredients from chewing gum. The pectin can be used in combination with a gum base containing about 10 to about 60 weight percent filler based on the weight of the gum base, specifically about 20 to about 50 weight percent, and yet more specifically about 30 to about 40 weight percent filler to further enhance release of lipophilic ingredients from the chewing gum during mastication.

Effective amounts of a variety of traditional ingredients further may be included in the gum base, such as coloring agents, antioxidants, preservatives, and the like. For example, titanium dioxide and other dyes suitable for food, drug and cosmetic applications, known as F.D. & C. dyes, may be utilized. An anti-oxidant such as butylated hydroxytoluene (BHT), butylated hydroxyanisole (BHA), propyl gallate, and combinations thereof, may also be included. Other conventional chewing gum additives known to one having ordinary skill in the chewing gum art may also be used in the chewing gum base.

The chewing gum composition containing the gum base may include bulk sweeteners such as sucrose or non-sucrose sweetening agents (sweeteners), high-intensity or artificial sweetenrs, plasticizers, softeners, emulsifiers, waxes, fillers, bulking agents (carriers, extenders), mineral adjuvants, flavorant (flavors, flavorings, flavoring agents), sensates, coloring agents (colorants, colorings), antioxidants, acidulants, thickeners, combinations thereof, and the like. Some of these additives may serve more than one purpose. For example, in sugarless chewing gum compositions, a sweetener, such as sorbitol or other sugar alcohol or combinations thereof, may also function as a bulking agent.

Bulk sweetening agents may include sugar sweeteners, sugarless sweeteners, or a combination of at least one of the foregoing sweetening agents.

Sugar sweeteners generally include saccharides. Suitable sugar sweeteners include mono-saccharides, di-saccharides and poly-saccharides such as but not limited to, sucrose (sugar), dextrose, maltose, dextrin, xylose, ribose, glucose, mannose, galactose, fructose (levulose), lactose, invert sugar, fructo oligo saccharide syrups, partially hydrolyzed starch, corn syrup solids, such as high fructose corn syrup, and combinations thereof.

Suitable sugarless sweetening agents include sugar alcohols (or polyols) such as, but not limited to, sorbitol, xylitol, mannitol, galactitol, maltitol, hydrogenated isomaltulose (isomalt), lactitol, erythritol, hydrogenated starch hydrolysate, stevia and combinations thereof.

The amount of bulk sweetening agent used in the chewing gum can be about 5 to about 95 weight percent of the final chewing gum composition, specifically about 25 to about 85 weight percent, more specifically about 35 to about 75 weight percent, and still more specifically about 45 to about 60 weight percent.

A “high intensity sweetener” as used herein means agents having a sweetness greater than the sweetness of sucrose. In some embodiments, a high intensity sweetener has a sweetness that is at least 100 times that of sugar (sucrose) on a per weight basis, specifically at least 500 times that of sugar on a per weight basis. In one embodiment the high intensity sweetener is at least 1,000 times that of sugar on a per weight basis, more specifically at least 5,000 times that of sugar on a per weight basis. The high intensity sweetener can be selected from a wide range of materials, including water-soluble sweeteners, water-soluble artificial sweeteners, water-soluble sweeteners derived from naturally occurring water-soluble sweeteners, dipeptide based sweeteners, and protein based sweeteners. Combinations comprising one or more sweeteners or one or more of the foregoing types of sweeteners can be used. Without being limited to particular sweeteners, representative categories and examples include:

water-soluble sweetening agents such as dihydrochalcones, monellin, steviosides, rebaudiosides, glycyrrhizin, dihydroflavenol, monatin, and L-aminodicarboxylic acid aminoalkenoic acid ester amides, such as those disclosed in U.S. Pat. No. 4,619,834, and a combination thereof;

water-soluble artificial sweeteners such as soluble saccharin salts, i.e., sodium or calcium saccharin salts, cyclamate salts, acesulfame salts, such as the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and a combination thereof; dipeptide based sweeteners, for example the L-aspartic acid derived sweeteners such as L-aspartyl-L-phenylalanine methyl ester (Aspartame) and materials described in U.S. Pat. No. 3,492,131, L-alpha-aspartyl-N-(2,2,4,4-tetramethyl-3-thietanyl)-D-alaninamide hydrate (Alitame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, neotame, and a combination thereof;

water-soluble sweeteners derived from naturally occurring water-soluble sweeteners, such as steviosides and stevia derived compounds such as but not limited to steviol glycosides such as rebaudiocides including rebaudiocide A, and the like, lo han quo and lo han quo derived compounds such as iso-mogroside V and the like, chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-furanoside, or 4,1′-dichloro-4,1′-dideoxygalactosucrose; 1′,6′-dichloro1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro-4,6,1′,6′-tetradeoxygalacto-sucrose; 4,6,1′,6′-tetradeoxy-sucrose, and a combination thereof;

protein based sweeteners such as thaumaoccous danielli, talin, and a combination thereof; and

amino acid based sweeteners.

Specifically the amount of high intensity sweetener, when used, can be present in an amount of about 0 to about 10 weight percent of the chewing gum composition, more specifically about 0.01 to about 5 weight percent, and even more specifically about 0.5 to about 2.5 weight percent of the chewing gum composition.

The chewing gum composition may comprise an additional flavorant in addition to the lipophilic flavorant previously discussed above. The additional flavorants may be used in many distinct physical forms well known in the art to provide an initial burst of flavor and/or a prolonged sensation of flavor. Without being limited thereto, such physical forms include free forms, such as spray dried, powdered, and beaded forms, and encapsulated forms, and combinations thereof.

The additional flavorant can be used in the chewing gum in an amount of about 0.05 to about 5 weight percent, specifically about 0.2 to about 4 weight percent, and yet more specifically about 0.6 to about 3.5 weight percent based on the weight of the chewing gum.

The coloring agents useful in the present compositions are used in amounts effective to produce the desired color. These coloring agents include pigments, which may be incorporated in amounts up to about 6%, by weight of the gum composition. An exemplary pigment, titanium dioxide, may be incorporated in amounts up to about 2%, and specifically less than about 1%, by weight of the gum composition. The colorants may also include natural food colors and dyes suitable for food, drug and cosmetic applications. These colorants are known as F.D.&C. dyes and lakes. The materials acceptable for the foregoing uses are specifically water-soluble. A full recitation of all F.D.&C. colorants and their corresponding chemical structures may be found in the Kirk-Othmer Encyclopedia of Chemical Technology, 3rd Edition, in volume 5 at pages 857-885, which text is incorporated herein by reference.

Exemplary amounts of coloring agent used in the chewing gum can be 0 to about 2 weight percent, specifically about 0.01 to about 1 weight percent, and yet more specifically about 0.05 to about 0.1 weight percent based on the weight of the chewing gum.

The plasticizers, softening agents, mineral adjuvants, waxes and antioxidants discussed above, as being suitable for use in the gum base, may also be used in the chewing gum composition. Examples of other conventional additives which may be used include emulsifiers, such as lecithin and glyceryl monostearate, acidulants or food acids such as malic acid, adipic acid, citric acid, tartaric acid, fumaric acid, and combinations thereof, and fillers, such as those discussed above under the category of mineral adjuvants.

The apparatus useful for manufacturing the chewing gum comprises mixing and heating apparatus well known in the chewing gum manufacturing arts, and therefore the selection of the specific apparatus will be apparent to the artisan. In preparing a chewing gum, a composition is made by admixing the gum base with the powdered hydrocolloid (e.g., unswollen, unhydrated and powdered pectin) described herein and the other ingredients of the final desired composition. The unswollen, unhydrated and powdered pectin can be added incorporated at any point in the process to prepare the chewing gum composition. Other ingredients will usually be incorporated into the composition as dictated by the nature of the desired composition as well known by those having ordinary skill in the art.

In an exemplary embodiment, a gum base is heated to a temperature sufficiently high to soften the base without adversely affecting the physical and chemical make up of the base. The optimal temperatures utilized may vary depending upon the composition of the gum base used, but such temperatures are readily determined by those skilled in the art without undue experimentation. The gum base is conventionally melted at temperatures that range from about 60° C. to about 120° C., specifically about 80° C. to about 100° C. for a period of time sufficient to render the base molten. For example, the gum base may be heated under those conditions for a period of about thirty minutes just prior to being admixed incrementally with the remaining ingredients of the gum such as plasticizers, softeners, bulking agents, sweeteners, the powdered pectin, and/or fillers, coloring agents, lipophilic sensates, lipophilic flavorants, and optional additional sensates and additional flavorants to plasticize the blend as well as to modulate the hardness, viscoelasticity and formability of the base. Mixing is continued until a uniform mixture of gum composition is obtained. Thereafter the gum composition mixture may be formed into desirable chewing gum shapes.

In another embodiment, a method of making a chewing gum comprises melting a gum base to form a molten gum base; mixing a bulking and sweetening agent with the molten gum base to form first mixture; mixing one or more of an artificial or high intensity sweetener, a colorant, an emulsifier, a lipophilic flavorant, a food acid, a lipophilic sensate, and a softener into the first mixture to form a second mixture; and mixing about 0.01% to about 10% by weight of powdered pectin into the molten gum base, the first mixture, or the second mixture, wherein the pectin is unswollen and unhydrated, and wherein the pectin is not as an encapsulant or an agglomerating agent.

A further embodiment has an emulsifier added to the molten gum base prior to the mixing a bulking and sweetening agent with the molten gum base.

In yet another embodiment, a softener is added to the first mixture prior to the mixing with an artificial or high intensity sweetener, a colorant, a lipophilic flavorant, a food acid, or a lipophilic sensate.

In still yet another embodiment, an artificial or high intensity sweetener is added after the mixing with the softener, colorant, a lipophilic flavorant, food acid, or a lipophilic sensate.

In one embodiment, the chewing gum is not a center-filled chewing gum.

In some embodiments, individual gum pieces may be coated with an aqueous outer coating composition using a conventional sugar or sugarless coating process in order to form a hard exterior shell on the chewing gum material. Such coatings may be applied by any method known in the art and may be hard or crunchy. In general, the coating is applied in numerous thin layers of material in order to form an appropriate uniform coated and finished quality surface on the gum products. The hard coating material, which may include sorbitol, maltitol, xylitol, isomalt, and other crystallizable polyols, including those described herein, and optionally a flavorant, is sprayed onto the pellets of gum material as they pass through a coating mechanism or a coating tunnel and are tumbled and rotated therein. In addition, conditioned air is circulated or forced into the coating tunnel or mechanism in order to dry each of the successive coating layers on the formed products.

The outer coating, if present, may include several thin, opaque layers, such that the chewing gum composition is not visible through the coating itself, which may optionally be covered with a further one or more transparent layers for aesthetic, textural and protective purposes. The outer coating may also contain small amounts of water and gum arabic. The outer coating may be further coated with wax. The outer coating may be applied in a conventional manner by successive applications of a coating solution, with drying in between each coat. As the outer coating dries it usually becomes opaque and is usually white, though other colorants may be added. Flavorants, sensates, or a combination thereof may also be added to the coating composition to yield unique product characteristics. The coating may further include colored flakes or speckles.

Various other coating compositions and methods of making are also contemplated including but not limited to soft panning, dual or multiple extrusion, lamination, etc. Thus, in some embodiments, the coating may be amorphous or crystalline and the resulting texture may be hard, crunchy, crispy, soft, or chewy.

### EXAMPLES

### Examples 1-30

### Chewing Gum Formulations Comprising Lipophilic Sensates and Powdered Pectin

Chewing gum formulations comprising lipophilic sensates and powdered pectin are prepared containing the following ingredients listed in Tables 1a, 1b, 1c, 1d and 1e; all amounts are in weight percent.

TABLE 1a

| | Example 1 | Example 2 | Example 3 | Example 4 | Example 5 | Example 6 |
|---|---|---|---|---|---|---|
| Gum base | 25-30 | 25-30 | 25-30 | 25-30 | 25-30 | 25-30 |
| Lecithin | 0.1-0.5 | 0.1-0.5 | 0.1-0.5 | 0.1-0.5 | 0.3-0.5 | 0.3-0.5 |
| Bulk sweetener | 45-60 | 45-60 | 45-60 | 45-60 | 50-60 | 50-60 |
| Glycerin | 4.5-6.0 | 4.5-6.0 | 4.5-6.0 | 4.5-6.0 | 4.5-6.0 | 4.5-8.0 |
| Coloring agent | 0.05-0.1 | 0.05-0.1 | 0.05-0.1 | 0.05-0.1 | 0.05-1.5 | 0.05-0.1 |
| Flavor | | | | | | |
| Fruit | 0.6-3.5 | — | 0.6-3.5 | — | 0.6-4.0 | — |
| Mint | — | 0.6-3.5 | — | 0.6-3.5 | — | 0.6-3.5 |
| Food acid | 0-3.0 | — | 0-3.0 | — | 0.5-1.5 | — |
| N-ethyl-2,2- | 0.25-0.5 | 0.4-0.6 | 0.25-0.5 | 0.4-0.6 | — | — |
| diisopropylbutanamide | | | | | | |
| Warming sensate | 0-0.25 | 0-0.65 | 0-0.25 | 0-0.65 | — | — |
| Jambu Oleoresin (30% | — | — | 0.001-0.008 | 0.001-0.0077 | 0.001-0.008 | 0.001-0.0077 |
| Spilanthol/triacetin) | | | | | | |
| Artificial/high- | 0.5-4.0 | 0.5-6.0 | 0.5-4.0 | 0.5-6.0 | 0.5-4.0 | 0.5-4.0 |
| intensity sweetner | | | | | | |
| Genu ® Pectin (Citrus) | 0.15 | 0.30 | 0.15 | 0.30 | 0.60-0.65 | 0.30-0.60 |
| type USP-L/200 (CP | | | | | | |
| Kelco) | | | | | | |
| Total | 100% | 100% | 100% | 100% | 100% | 100% |

TABLE 1b

| | | | | Example | Example | Example |
|---|---|---|---|---|---|---|
| | Example 7 | Example 8 | Example 9 | 10 | 11 | 12 |
| Gum base | 25-30 | 25-30 | 25-30 | 25-30 | 25-30 | 25-30 |
| Lecithin | 0.1-0.5 | 0.1-0.5 | 0.1-0.5 | 0.1-0.5 | 0.3-0.5 | 0.3-0.5 |
| Bulk sweetener | 45-60 | 45-60 | 45-60 | 45-60 | 50-60 | 50-60 |
| Glycerin | 4.5-6.0 | 4.5-6.0 | 4.5-6.0 | 4.5-6.0 | 4.5-6.0 | 4.5-8.0 |
| Coloring agent | 0.05-0.1 | 0.05-0.1 | 0.05-0.1 | 0.05-0.1 | 0.05-1.5 | 0.05-0.1 |
| Flavor | | | | | | |
| Fruit | 0.6-3.5 | — | 0.6-3.5 | — | 0.6-4.0 | — |
| Mint | — | 0.6-3.5 | — | 0.6-3.5 | — | 0.6-3.5 |
| Food acid | 0-3.0 | — | 0-3.0 | — | 0.5-1.5 | — |
| N-(4- | 0.3-0.5 | 0.3-0.5 | 0.3-0.5 | 0.3-0.5 | — | — |
| (cyanomethyl)phenyl)- | | | | | | |
| 2-isopropyl-5- | | | | | | |
| methylcyclohexane- | | | | | | |
| carboxamide, spray | | | | | | |
| dried | | | | | | |
| N-ethyl-p-menthane- | — | — | — | — | 0.04-0.06 | 0.1-0.2 |
| 3-carboxamide (WS-3) | | | | | | |
| Monomenthyl | — | — | — | — | 0.009-0.02 | 0.075-0.2 |
| glutarate | | | | | | |
| Warming sensate | 0-0.25 | 0-0.65 | 0-0.25 | 0-0.65 | — | — |
| Jambu Oleoresin (30% | — | — | 0.001-0.008 | 0.001-0.0077 | 0.001-0.008 | 0.001-0.0077 |
| Spilanthol/triacetin) | | | | | | |
| Artificial/high- | 0.5-4.0 | 0.5-6.0 | 0.5-4.0 | 0.5-6.0 | 0.5-4.0 | 0.5-4.0 |
| intensity sweetner | | | | | | |
| Genu ® Pectin (Citrus) | 0.15 | 0.30 | 0.15 | 0.30 | 0.60-0.65 | 0.30-0.60 |
| type USP-L/200 (CP | | | | | | |
| Kelco) | | | | | | |
| Total | 100% | 100% | 100% | 100% | 100% | 100% |

TABLE 1c

| | Example | Example | Example | Example | Example | Example |
|---|---|---|---|---|---|---|
| | 13 | 14 | 15 | 16 | 17 | 18 |
| Gum base | 25-30 | 25-30 | 25-30 | 25-30 | 25-30 | 25-30 |
| Lecithin | 0.1-0.5 | 0.1-0.5 | 0.1-0.5 | 0.1-0.5 | 0.3-0.5 | 0.3-0.5 |
| Bulk sweetener | 45-60 | 45-60 | 45-60 | 45-60 | 50-60 | 50-60 |
| Glycerin | 4.5-6.0 | 4.5-6.0 | 4.5-6.0 | 4.5-6.0 | 4.5-6.0 | 4.5-8.0 |
| Coloring agent | 0.05-0.1 | 0.05-0.1 | 0.05-0.1 | 0.05-0.1 | 0.05-1.5 | 0.05-0.1 |
| Flavor | | | | | | |
| Fruit | 0.6-3.5 | — | 0.6-3.5 | — | 0.6-4.0 | — |
| Mint | — | 0.6-3.5 | — | 0.6-3.5 | — | 0.6-3.5 |
| Food acid | 0-3.0 | — | 0-3.0 | | 0.5-1.5 | — |
| N-ethyl-p-menthane- | 0.01-0.04 | 0.01-0.04 | 0.01-0.04 | 0.01-0.04 | 0.04-0.06 | 0.1-0.2 |
| 3-carboxamide (WS-3) | | | | | | |
| Monomenthyl | — | 0.05-0.3 | — | 0.05-0.3 | 0.009-0.02 | 0.075-0.2 |
| glutarate | | | | | | |
| Warming sensate | 0-0.25 | 0-0.65 | 0-0.25 | 0-0.65 | — | — |
| Artificial/high- | 0.5-4.0 | 0.5-6.0 | 0.5-4.0 | 0.5-6.0 | 0.5-4.0 | 0.5-4.0 |
| intensity sweetner | | | | | | |
| Genu ® Pectin (Citrus) | 0.15 | 0.30 | 0.15 | 0.30 | 0.60-0.65 | 0.30-0.60 |
| type USP-L/200 (CP | | | | | | |
| Kelco) | | | | | | |
| Total | 100% | 100% | 100% | 100% | 100% | 100% |

TABLE 1d

| | Example | Example | Example | Example | Example | Example |
|---|---|---|---|---|---|---|
| | 19 | 20 | 21 | 22 | 23 | 24 |
| Gum base | 25-30 | 25-30 | 25-30 | 25-30 | 25-30 | 25-30 |
| Lecithin | 0.1-0.5 | 0.1-0.5 | 0.1-0.5 | 0.1-0.5 | 0.1-0.5 | 0.1-0.5 |
| Bulk sweetener | 45-60 | 45-60 | 45-60 | 45-60 | 45-60 | 45-60 |
| Glycerin | 4.5-8.0 | 4.5-8.0 | 4.5-8.0 | 4.5-8.0 | 4.5-8.0 | 4.5-8.0 |
| Coloring agent | 0.05-0.1 | 0.05-0.1 | 0.05-0.1 | 0.05-0.1 | 0.05-1.5 | 0.05-0.1 |
| Flavor | | | | | | |
| Fruit | 0.5-4.0 | — | 0.5-4.0 | — | 0.5-4.0 | — |
| Mint | — | 0.5-4.0 | — | 0.5-4.0 | — | 0.5-4.0 |
| Food acid | 0-3.0 | — | 0-3.0 | — | 0-3.0 | — |
| N-ethyl-2,2- | 0-0.5 | 0-0.6 | 0-0.5 | 0-0.6 | 0-0.5 | 0-0.6 |
| diisopropylbutanamide | | | | | | |
| N-(4- | 0-0.5 | 0-0.5 | 0-0.5 | 0-0.5 | 0-0.5 | 0-0.5 |
| (cyanomethyl)phenyl)- | | | | | | |
| 2-isopropyl-5- | | | | | | |
| methylcyclohexane- | | | | | | |
| carboxamide, spray | | | | | | |
| dried | | | | | | |
| N-ethyl-p-menthane- | 0-0.06 | 0-0.2 | 0-0.06 | 0-0.2 | 0-0.06 | 0-0.2 |
| 3-carboxamide (WS-3) | | | | | | |
| Monomenthyl | 0-0.02 | 0-0.3 | 0-0.02 | 0-0.3 | 0-0.02 | 0-0.3 |
| glutarate | | | | | | |
| Warming sensate | 0-0.65 | 0-0.65 | 0-0.65 | 0-0.65 | 0-0.65 | 0-0.65 |
| Jambu Oleoresin (30% | 0-0.009 | 0-0.009 | 0-0.009 | 0-0.009 | 0-0.009 | 0-0.009 |
| Spilanthol/triacetin) | | | | | | |
| Artificial/high- | 0.5-6.0 | 0.5-6.0 | 0.5-6.0 | 0.5-6.0 | 0.5-6.0 | 0.5-6.0 |
| intensity sweetner | | | | | | |
| Genu ® Pectin (Citrus) | 0.15-0.65 | 0.15-0.65 | 0.15-0.65 | 0.15-0.65 | 0.15-0.65 | 0.15-0.65 |
| type USP-L/200 (CP Kelco) | | | | | | |
| Total | 100% | 100% | 100% | 100% | 100% | 100% |

TABLE 1e

| | Example | Example | Example | Example | Example | Example |
|---|---|---|---|---|---|---|
| | 25 | 26 | 27 | 28 | 29 | 30 |
| Gum base | 25-30 | 25-30 | 25-30 | 25-30 | 25-30 | 25-30 |
| Lecithin | 0.1-0.5 | 0.1-0.5 | 0.1-0.5 | 0.1-0.5 | 0.1-0.5 | 0.1-0.5 |
| Bulk sweetener | 45-60 | 45-60 | 45-60 | 45-60 | 45-60 | 45-60 |
| Glycerin | 4.5-8.0 | 4.5-8.0 | 4.5-8.0 | 4.5-8.0 | 4.5-8.0 | 4.5-8.0 |
| Coloring agent | 0.05-0.1 | 0.05-0.1 | 0.05-0.1 | 0.05-0.1 | 0.05-1.5 | 0.05-0.1 |
| Flavor | | | | | | |
| Fruit | 0.5-4.0 | — | 0.5-4.0 | — | 0.5-4.0 | — |
| Mint | — | 0.5-4.0 | — | 0.5-4.0 | — | 0.5-4.0 |
| Food acid | 0-3.0 | — | 0-3.0 | — | 0-3.0 | — |
| N-ethyl-2,2- | 0-0.5 | 0-0.6 | 0-0.5 | 0-0.6 | 0-0.5 | 0-0.6 |
| diisopropylbutanamide | | | | | | |
| N-(4- | 0-0.5 | 0-0.5 | 0-0.5 | 0-0.5 | 0-0.5 | 0-0.5 |
| (cyanomethyl)phenyl)- | | | | | | |
| 2-isopropyl-5- | | | | | | |
| methylcyclohexane- | | | | | | |
| carboxamide, spray | | | | | | |
| dried | | | | | | |
| N-ethyl-p-menthane- | 0-0.06 | 0-0.2 | 0-0.06 | 0-0.2 | 0-0.06 | 0-0.2 |
| 3-carboxamide (WS-3) | | | | | | |
| Monomenthyl | 0-0.02 | 0-0.3 | 0-0.02 | 0-0.3 | 0-0.02 | 0-0.3 |
| glutarate | | | | | | |
| Warming sensate | 0-0.65 | 0-0.65 | 0-0.65 | 0-0.65 | 0-0.65 | 0-0.65 |
| Jambu Oleoresin (30% | 0-0.009 | 0-0.009 | 0-0.009 | 0-0.009 | 0-0.009 | 0-0.009 |
| Spilanthol/triacetin) | | | | | | |
| Artificial/high- | 0.5-6.0 | 0.5-6.0 | 0.5-6.0 | 0.5-6.0 | 0.5-6.0 | 0.5-6.0 |
| intensity sweetner | | | | | | |
| Genu ® Pectin (Citrus) | 0.65-4.0 | 0.65-4.0 | 0.65-4.0 | 0.65-4.0 | 0.65-4.0 | 0.65-4.0 |
| type USP-L/200 (CP Kelco) | | | | | | |
| Total | 100% | 100% | 100% | 100% | 100% | 100% |

The chewing gum formulations are prepared by heating the gum base to a temperature of 90° C. in a gum base container until it melts and hold for about 1 minute. Lecithin is then added with mixing for about 1 minute. Bulk sweeteners are then added to the molten gum base and lecithin blend and mixed for about 5 minutes where the temperature is reduced to about 45-50° C. Glycerin is then added with mixing and is mixed for about 5 minutes. The lipophilic sensate(s), additional flavorant, food acid, and coloring agent are added with mixing and the mixture is mixed for about 5 minutes. Artificial sweeteners are then added with mixing and mixed for about 2 minutes. The powdered pectin is added with mixing and mixed for about 3 minutes to form the final chewing gum composition.

Sensory evaluations of chewing gum formulations comprising N-ethyl-2,2-diisopropylbutanamide and powdered pectin were conducted by nine groups of evaluators (n=4-6/group) for mint and fruit-flavored formulations. The results show that a mint-flavored chewing gum formulation containing N-ethyl-2,2-diisopropylbutanamide and powdered pectin provides an adequate delivery of an instant mint flavor without being too sweet; the flavor is described as long lasting and minty; and most evaluators felt the cooling sensation helped to increase the duration of the overall flavor. The results show that a fruit-flavored chewing gum formulation containing N-ethyl-2,2-diisopropylbutanamide and powdered pectin provides a flavorful, fruity, and long lasting flavor.

As used herein the transitional term “comprising,” (also “comprises,” etc.) which is synonymous with “having”, “including,” “containing,” or “characterized by,” is inclusive or open-ended and does not exclude additional, unrecited elements or method steps, regardless of its use in the preamble or the body of a claim.

The singular forms “a,” “an,” and “the” include plural referents unless the context clearly dictates otherwise.

The endpoints of all ranges directed to the same characteristic or component are independently combinable, and inclusive of the recited endpoint.

The word “or” means “and/or.”

Reference throughout the specification to “one embodiment”, “other embodiments”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed as the best mode contemplated for carrying out this invention, but that the invention will include all embodiments falling within the scope of the appended claims.

What is claimed is:

1. A chewing gum composition, comprising:
about 5% to about 90% by weight gum base;
about 5% to about 95% by weight bulking and sweetening agents;
about 0.001% to about 5.0% by weight of a lipophilic flavorant or lipophilic sensate; and
about 0.01% to about 10% by weight of pectin, wherein all weights are based on the total weight of the chewing gum composition; wherein the pectin is unswollen and unhydrated; and
wherein the pectin is incorporated directly into the chewing gum composition in a powder form and not as an encapsulant or an agglomerating agent.

2. The chewing gum composition of claim 1, wherein the chewing gum composition comprises a lipophilic sensate selected from the group consisting of a physiological cooling agent comprising, a warming agent, a tingling agent, and combinations thereof.

3. The chewing gum composition of claim 1, wherein the lipophilic sensate is capsaicin, N-(4-(cyanomethyl)phenyl)-2-isopropyl-5-methylcyclohexane-carboxamide, N-ethyl-2,2-diisopropylbutanamide, N-ethyl-p-menthane-3-carboxamide, ethyl 2-[(5-methyl-2-propan-2-ylcyclohexanecarbonyl)amino]acetate, jambu oleoresin, menthol, menthone, monomenthyl glutarate, menthyl lactate, trans-pellitorin, spilanthol, synthetic spilanthol, N,2,3-trimethyl-2-propan-2-ylbutanamide, vanillyl alcohol n-butylether, vanillyl alcohol ethylether, and combinations thereof.

4. The chewing gum of claim 1, wherein the chewing gum composition comprises N-ethyl-2,2-diisopropylbutanamide.

5. The chewing gum of claim 1, comprising about 0.1% to about 3.0% by weight of a lipophilic flavorant or lipophilic sensate.

6. The chewing gum of claim 1, comprising about 0.5% to about 1.0% by weight of a lipophilic flavor or lipophilic sensate.

7.-9. (canceled)

10. The chewing gum of claim 1, comprising about 0.1% to about 7% by weight of pectin.

11. The chewing gum of claim 1, comprising about 0.15% to about 4% by weight of pectin.

12. The chewing gum of claim 1, comprising about 0.3% to about 1% by weight of pectin.

13. The chewing gum of claim 1, comprising about 0.05% to about 0.7% by weight of pectin.

14. The chewing gum of claim 1, comprising about 0.15% to about 0.6% by weight of pectin.

15. The chewing gum of claim 1, comprising about 0.25% to about 0.3% by weight of pectin.

16. The chewing gum of claim 1, comprising about 10% to about 70% by weight gum base.

17.-18. (canceled)

19. The chewing gum of claim 1, comprising about 25% to about 85% by weight bulking and sweetening agents.

20.-21. (canceled)

22. The chewing gum of claim 1, wherein the chewing gum comprises 0 to about 3% by weight of rubber.

23. The chewing gum of claim 1, wherein the pectin is in the form of particles consisting of pectin, particles of pectin coated with a polymer, or particles consisting of pectin dispersed in a polymer.

24. The chewing gum of claim 1, further comprising one or more of a high intensity sweetener, a colorant, an emulsifier, an additional flavorant, a food acid, an additional sensate, and a softener.

25. The chewing gum of claim 1, wherein the particle size of the pectin is greater than or equal to about 70 micrometers as determined by sieve analysis

26. The chewing gum of claim 1, wherein the chewing gum is not a center-fill chewing gum.

27. A method of making a chewing gum composition, comprises:
melting a gum base to form a molten gum base;
mixing a bulking and sweetening agent with the molten gum base to form first mixture;
mixing a lipophilic sensate, a lipophilic flavorant, or a combination thereof into the first mixture to form a second mixture; and
mixing about 0.01% to about 10% by weight of powdered pectin into the molten gum base, the first mixture, or the second mixture,
wherein the pectin is unswollen and unhydrated, and
wherein the pectin is not as an encapsulant or an agglomerating agent.

28.-31. (canceled)
